(19) United States
(12) Patent Application Publication
(10) Pub. No.: US 2006/0064634 A1
(43) Pub. Date: Mar. 23, 2006

(54) Editing multiple file versions

(75) Inventors: Richard Dean Dettinger, Rochester, MN (US); Frederick Allyn Kulack, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/944,623

(22) Filed: Sep. 17, 2004

(51) Int. Cl. G06F 17/24; G06F 17/30

(52) U.S. Cl. 715/511; 707/1; 715/530

(57) ABSTRACT

A method, apparatus, system, and signal-bearing medium that, in an embodiment, create an amalgamated file based on differences between versions of files. When an edit command directed to the amalgamated file is received, the file to which the edit command applies is determined and a change tag is added to the amalgamated file. The change tag includes at least an identification of the file to which the edit applies. In various embodiments, the file to which the edit command applies is determined based on a specification in the edit command or based on the location in the amalgamated file to which the edit command is directed. Data in the amalgamated file is saved by finding the change tags in the amalgamated file, and saving the associated data to the files identified in the change tags. The amalgamated file may be displayed in a number of different views, where the views display respective subsets of the differences based on the files to which they apply. In an embodiment, one of the views displays all of the differences between the files. In another embodiment, another of the views displays the differences between only some of the files.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### FIELD

An embodiment of the invention generally relates to computers. In particular, an embodiment of the invention generally relates to editing multiple versions of a file simultaneously.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware components (such as semiconductors, integrated circuits, programmable logic devices, programmable gate arrays, power supplies, electronic card assemblies, sheet metal, cables, and connectors) and software, also known as computer programs.

A computer program often exists in multiple versions. For example, different versions may exist for different operating systems or for different hardware platforms. Further, another version may be under development for a future release, and multiple versions may exist for previous releases that are in maintenance status. Keeping track of all these versions of programs and making changes to the multiple versions is a difficult task for the software developer.

Computer programs are written by computer programmers or software developers using an editor, which is another program that allows the entering and modification of the computer programming code. In addition to editors, to aid the software developer, library control systems currently exist that create different per-user (private) paths for each branch or release of the programs and allow the software developers to move back and forth between the releases and access the files in those releases. Tools also exist that compare one program to another and merge the changes from one program into the other. Unfortunately, a simple compare and merge tool is not enough assistance for the software developer, especially when more than two versions of the program are involved, multiple software developers are changing the programs, and changes are not necessarily cumulative between the versions.

To further understand the problem, consider an example with three versions of a computer program, where the third version includes some code that exists only in the third version, some code that is in common only with the second version, some code that is in common only with the first version, and some code that is in common with both the first version and the second version. Thus, while although the third version may have been created later in time than the first and second versions, the changes are not cumulative from the first version to the second version, and from the second version to the third version. Hence, simply comparing the third version to the second version and then merging the changes from the third version into the second version will yield unpredictable and undesired results since to do so would add code to the second version that the third version has in common with the first version, which was never intended to be in the second version.

Without a better way to manage multiple versions of computer programs, software developers will continue to struggle with maintaining multiple releases. Although the aforementioned problems have been described in the context of multiple versions of computer programs, they may occur in files of any type.

### SUMMARY

A method, apparatus, system, and signal-bearing medium are provided that, in an embodiment, create an amalgamated file based on differences between files. When an edit command directed to the amalgamated file is received, the file to which the edit command applies is determined and a change tag is added to the amalgamated file. The change tag includes at least an identification of the file to which the edit applies. In various embodiments, the file to which the edit command applies is determined based on a specification in the edit command or based on the location in the amalgamated file to which the edit command is directed. Data in the amalgamated file is saved by finding the change tags in the amalgamated file, and saving the associated data to the files identified in the change tags.

The amalgamated file may be displayed in a number of different views, where the views display respective subsets of the differences based on the files to which they apply. In an embodiment, one of the views displays all of the differences between the files. In another embodiment, another of the views displays the differences between only some of the files.

### BRIEF DESCRIPTION OF THE DRAWING

FIG. 1 depicts a block diagram of an example system for implementing an embodiment of the invention.

FIG. 2 depicts a pictorial representation of a user interface for an editor, according to an embodiment of the invention.

FIG. 3 depicts a block diagram of an amalgamated file, according to an embodiment of the invention.

FIG. 4 depicts a flowchart of example processing for a file open command by an editor, according to an embodiment of the invention.

FIG. 5 depicts a flowchart of example processing for an edit command by an editor, according to an embodiment of the invention.

FIG. 6 depicts a flowchart of example processing for a file save command by an editor, according to an embodiment of the invention.

FIG. 7 depicts a flowchart of example processing for views of the amalgamated file, according to an embodiment of the invention.

### DETAILED DESCRIPTION

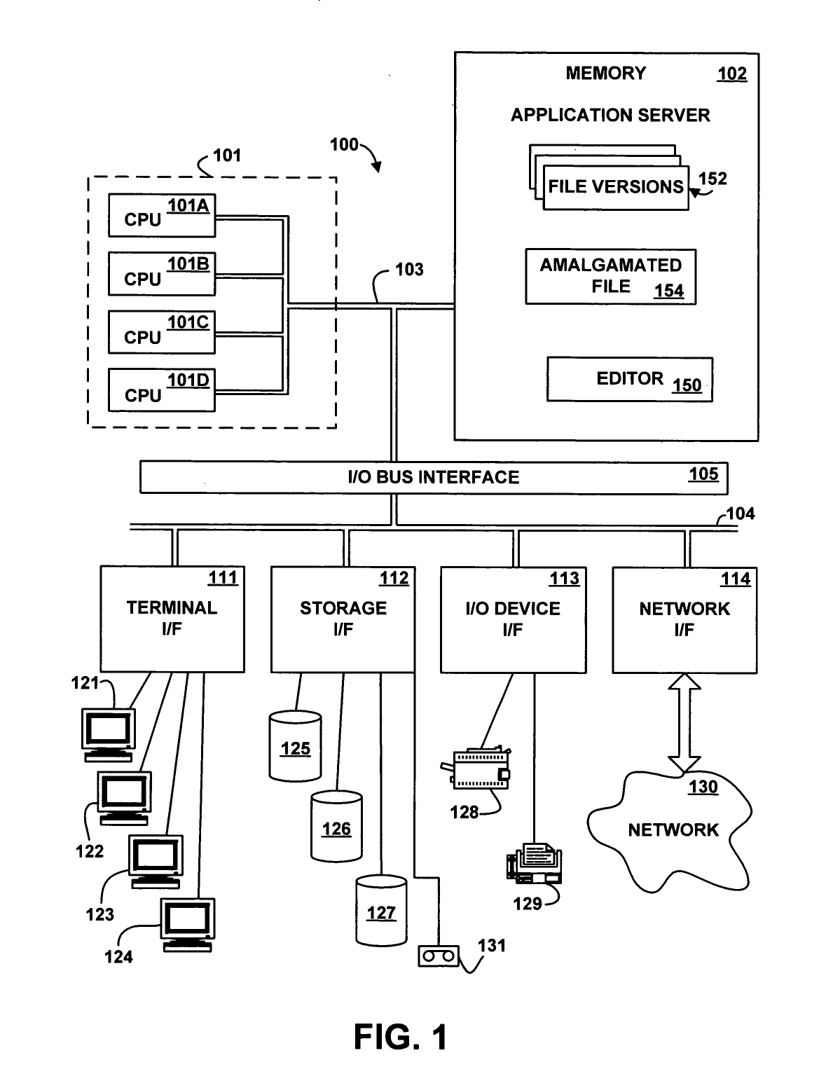

Referring to the Drawing, wherein like numbers denote like parts throughout the several views, FIG. 1 depicts a high-level block diagram representation of a computer system 100 connected to a network 130, according to an embodiment of the present invention. The major components of the computer system 100 include one or more processors 101, main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment, the computer system 100 may alternatively be a single CPU system. Each processor 101 executes instructions stored in the main memory 102 and may include one or more levels of on-board cache.

Each processor 101 may be implemented as a single threaded processor, or as a multithreaded processor. For the most part, each hardware thread in a multithreaded processor is treated like an independent processor by the software resident in the computer 100. In this regard, for the purposes of this disclosure, a single threaded processor will be considered to incorporate a single hardware thread, i.e., a single independent unit of execution. It will be appreciated, however, that software-based multithreading or multitasking may be used in connection with both single threaded and multithreaded processors to further support the parallel performance of multiple tasks in the computer 100.

The main memory 102 is a random-access semiconductor memory for storing data and programs. The main memory 102 is conceptually a single monolithic entity, but in other embodiments, the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may further be distributed and associated with different CPUs or sets of CPUs, as is known in any of various so-called non-uniform memory access (NUMA) computer architectures.

The main memory 102 includes an editor 150, multiple file versions 152, and an amalgamated file 154. Although the editor 150, the file versions 152, and the amalgamated file 154 are illustrated as being contained within the memory 102 in the computer system 100, in other embodiments, some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the editor 150, the file versions 152, and the amalgamated file 154 are all illustrated as being contained within the memory 102 in the computer system 100, these elements are not necessarily all completely contained in the same storage device at the same time.

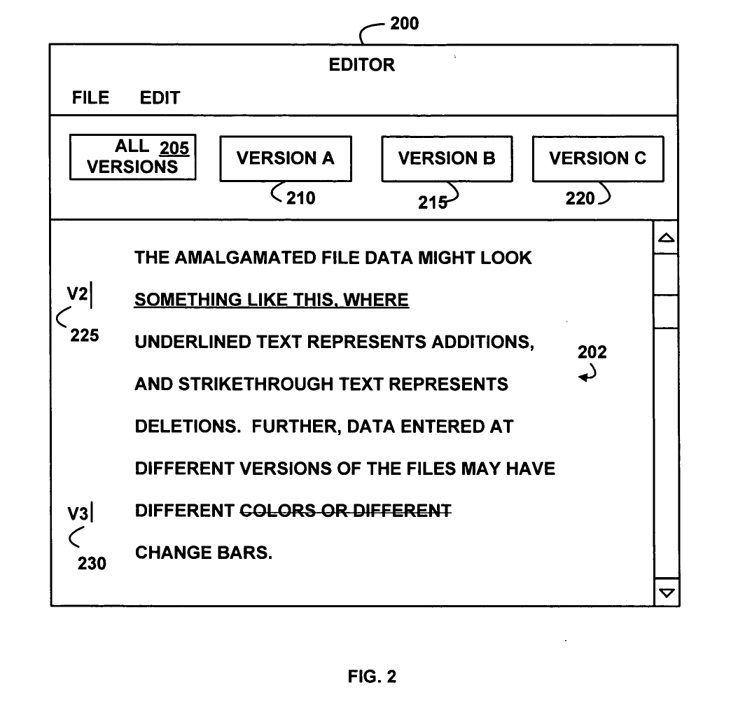

The editor 150 creates the amalgamated file 154 from the file versions 152, allows a user to change the amalgamated file 154, and then saves the changes to the file versions 152. In an embodiment, the editor 150 includes instructions capable of executing on the processor 101 or statements capable of being interpreted by instructions executing on the processor 101 to perform the functions as further described below with reference to FIGS. 2, 3, 4, 5, 6, and 7. In another embodiment, the editor 150 may be implemented in microcode. In yet another embodiment, the editor 150 may be implemented in hardware via logic gates and/or other appropriate hardware techniques, in lieu of or in addition to a processor-based system.

The file versions 152 may have some data in common and some data not in common. To further illustrate, in a three version example, some data may exist only in the first version, some data may exist only in the second version, some data may exist only in the third version, some data may exist only in the first version and the second version, some data may exist only in the first version and the third version, some data may exist only in the second version and the third version, some data may be common to all versions, or any combination thereof. In various embodiments, the file versions 152 may include program code, text, objects, images, graphics, video, control tags, any other appropriate data, or any combination thereof. Further, the file versions 152 may be flat files, databases, or web pages, or any other appropriate data repository.

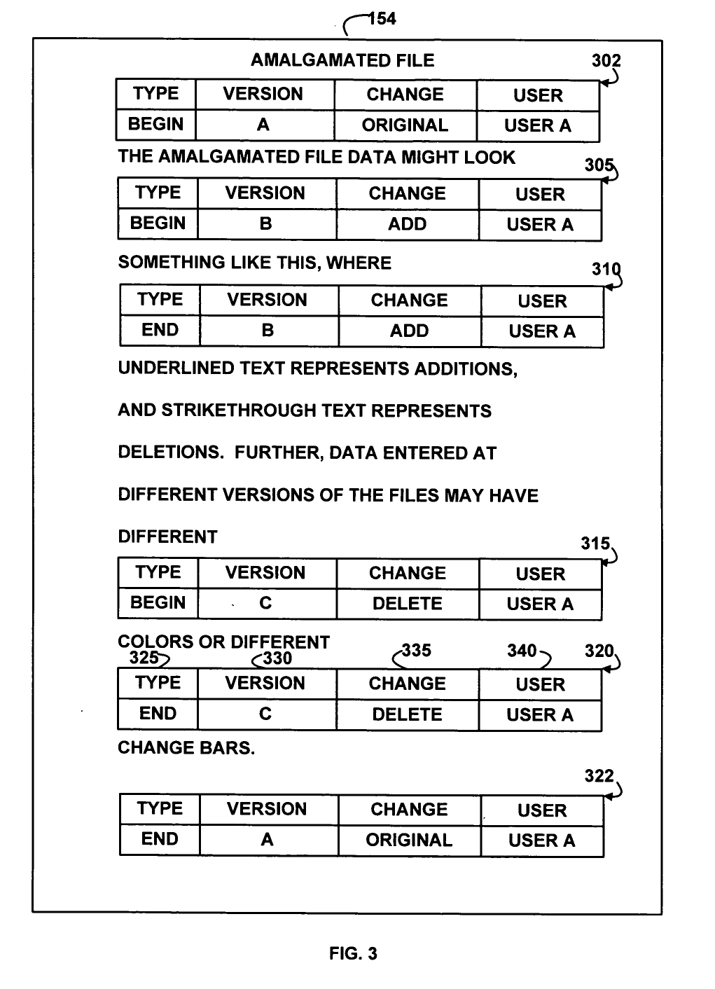

In an embodiment, the amalgamated file 154 may be a permanent file. But, in other embodiments, the amalgamated file 154 may be a temporary file, a cache, or a buffer. The editor 150 uses the amalgamated file 154 to display a user interface, as further described below with reference to FIG. 2. The amalgamated file 154 is further described below with reference to FIG. 3.

The memory bus 103 provides a data communication path for transferring data among the processors 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interconnect) bus, or any other appropriate bus technology. The I/O interface units support communication with a variety of storage and I/O devices. For example, the terminal interface unit 111 supports the attachment of one or more user terminals 121, 122, 123, and 124.

The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the DASD 125, 126, and 127 may be loaded from and stored to the memory 102 as needed. The storage interface unit 112 may also support other types of devices, such as a tape device 131, an optical device, or any other type of storage device.

The I/O and other device interface 113 provides an interface to any of various other input/output devices or devices of other types. Two such devices, the printer 128 and the fax machine 129, are shown in the exemplary embodiment of FIG. 1, but in other embodiments, many other such devices may exist, which may be of differing types.

The network interface 114 provides one or more communications paths from the computer system 100 to other digital devices and computer systems; such paths may include, e.g., one or more networks 130. In various embodiments, the network interface 114 may be implemented via a modem, a LAN (Local Area Network) card, a virtual LAN card, or any other appropriate network interface or combination of network interfaces.

Although the memory bus 103 is shown in FIG. 1 as a relatively simple, single bus structure providing a direct communication path among the processors 101, the main memory 102, and the I/O bus interface 105, in fact, the memory bus 103 may comprise multiple different buses or communication paths, which may be arranged in any of various forms, such as point-to-point links in hierarchical, star or web configurations, multiple hierarchical buses, parallel and redundant paths, etc. Furthermore, while the I/O bus interface 105 and the I/O bus 104 are shown as single respective units, the computer system 100 may, in fact, contain multiple I/O bus interface units 105 and/or multiple I/O buses 104. While multiple I/O interface units are shown, which separate the system I/O bus 104 from various communications paths running to the various I/O devices, in other embodiments, some or all of the I/O devices are connected directly to one or more system I/O buses.

The computer system 100, depicted in FIG. 1, has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a firewall, router, Internet Service Provider (ISP), personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In an embodiment, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line, cable, or bus. In another embodiment, the network 130 may support the Ethernet IEEE (Institute of Electrical and Electronics Engineers) 802.3x specification.

In another embodiment, the network 130 may be the Internet and may support IP (Internet Protocol). In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present.

It should be understood that FIG. 1 is intended to depict the representative major components of the computer system 100 and the network 130 at a high level, that individual components may have greater complexity than represented in FIG. 1, that components other than, fewer than, or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements embodying the various aspects of an embodiment of the invention.

Moreover, while embodiments of the invention have and hereinafter will be described in the context of fully functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of signal-bearing media, which include, but are not limited to:

(1) information permanently stored on a non-rewriteable storage medium, e.g., a read-only memory device attached to or within a computer system, such as a CD-ROM readable by a CD-ROM drive;

(2) alterable information stored on a rewriteable storage medium, e.g., a hard disk drive (e.g., DASD 125, 126, or 127), CD-RW, or diskette; or

(3) information conveyed to the computer system 100 by a communications medium, such as through a computer or a telephone network, e.g., the network 130, including wireless communications.

Such signal-bearing media, when carrying machine-readable instructions that direct the functions of the present invention, represent embodiments of the present invention.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2 depicts a pictorial representation of a user interface 200 for the editor 150, according to an embodiment of the invention. The user interface 200 allows the user to open, view, edit, and save the amalgamated file 154 via the editor 150. The user interface 200 includes a display 202 of the amalgamated file 154.

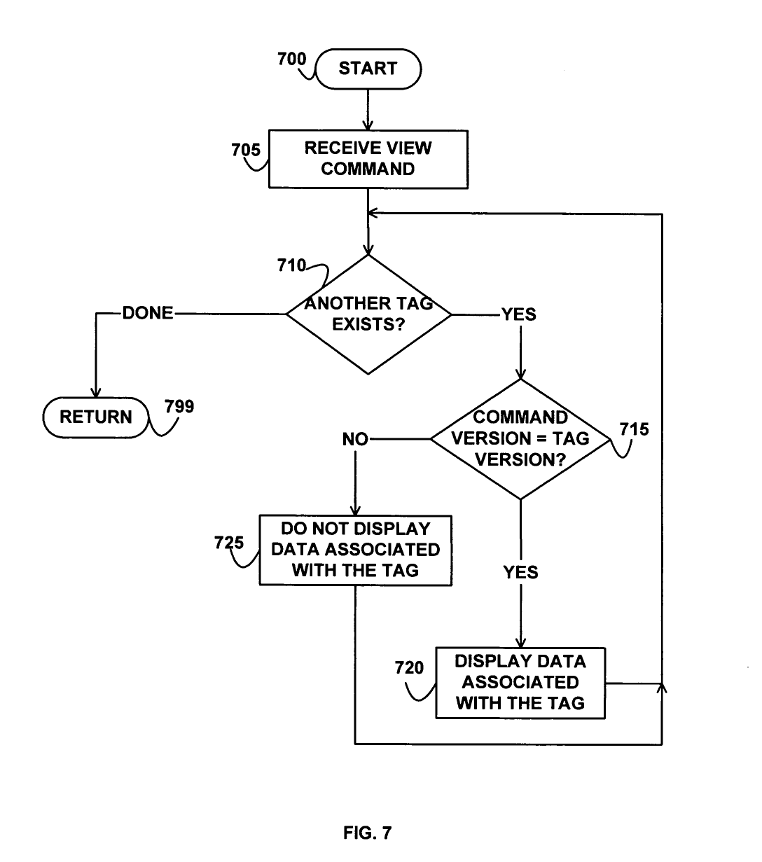

The user interface 200 further includes view buttons 205, 210, 215, and 220, but in other embodiments any number of buttons and any appropriate user interface elements for entering view commands may be used. The view buttons 205, 210, 215, and 220 allow the user to request that the editor 150 display different views of the amalgamated file 154, as further described below with reference to FIG. 7.

For example, in response to selection of the view button 205, the editor 150 displays in the display 202 the contents of all of the file versions 152, including change indications of how the various versions are different from each other. In response to selection of the view button 210, the editor 150 displays in the display 202 the contents of version A of the file versions 152. In response to selection of the view button 215, the editor 150 displays in the display 202 the contents of the version B of the file versions 152 and indications of how version B is different from version A of the file versions 152. In response to selection of the view button 220, the editor 150 displays in the display 202 the contents of version C of the file versions 152 and indications of how the version C is different from the version A of the file versions 152. In response to selection of multiple of the view buttons 210, 215, and 220, the editor 150 displays, in the display 202, multiple of the file versions 152 and change indications of how they are different from the version A. Thus, selection of the buttons 205, 210, 215, 220, or a combination thereof, cause the editor 150 to switch between views of the amalgamated file 154, where the views display respective subsets of differences between the file versions 152.

The display 202 further includes a change indication 225 and a change indication 230. The change indication 225 and the change indications 230 emphasize that changes have been made at these locations and further indicate the version or versions of the file versions 152 in which the associated data exists. The additional data is further flagged with a change indication, such as an underline font for additions and strikethrough font for deletions. Although an underline font is illustrated to indicate an addition and a strikethrough font is illustrated to indicate a deletion in FIG. 2, in other embodiments, double underlining, balloons, brackets, color, highlighting, reverse video, or any other appropriate type of change indications may be used. Although only one version, e.g., “V2” associated with the change indication 225 and “V3” associated with the change indication 230, in another embodiment, change indications may include multiple versions, to indicate that the change was made to multiple of the file versions 152.

FIG. 3 depicts a block diagram of the amalgamated file 154, according to an embodiment of the invention. The amalgamated file 154 is created by the editor 150 and includes change tags 302, 305, 310, 315, 320, and 322 plus data from some or all of the file versions 152. Each of the change tags 302, 305, 310, 315, 320, and 322 includes a type field, a version field, a change field, and a user field, such as the example type field 325, version field 330, change field 335, and user field 340. The type field 325 includes an identification of the type of change tag, such as the begin tags 305 and 315 and the end tags 310 and 320. A begin tag and its respective end tag delineate associated data in the amalgamated file 154.

The version field 330 indicates which version in the file versions 152 is associated with the change tag. Although only one version is illustrated in the version field 330, in other embodiment the version field 330 may include multiple versions, indicating that the associated data was changed in multiple versions of the file versions 152. In another embodiment, multiple change tags may be used in lieu of multiple versions in the versions field 330.

The change field 335 indicates the type of change that is associated with the data delineated by the respective begin and end tag. The user field 340 indicates the user who requested the change, but in another embodiment the user field 340 may include other data in lieu of or in addition to the user information, such as data from a library control system, the date and/or time of the change, or the branch or product release associated with the change. In other embodiments, more or fewer fields may be present in the change tags, for example, the user field 340 may be optional or not used.

In the example shown, the begin tag 302 and the end tag 322 have “original” in the change field, which indicates that the associated data within the tags 302 and 322 (with the exception of data associated with the embedded tags 305, 310, 315, and 320) was original to version A. In an further example, the begin tag 305 and the end tag 310 have “add” in the change field, which indicates that the associated data, “something like this, where” was added in version B of the file versions 152 by the user A. Also, the begin tag 315 and the end tag 320 have “delete” in the change field, which indicates that the associated data, “colors or different” was added in version C of the file versions 152 by the user A.

Since the changes to the file versions 152 are not necessarily cumulative, in an embodiment, the amalgamated file 154 may not represent any of the file versions 152 and instead may represent a combination of some of them.

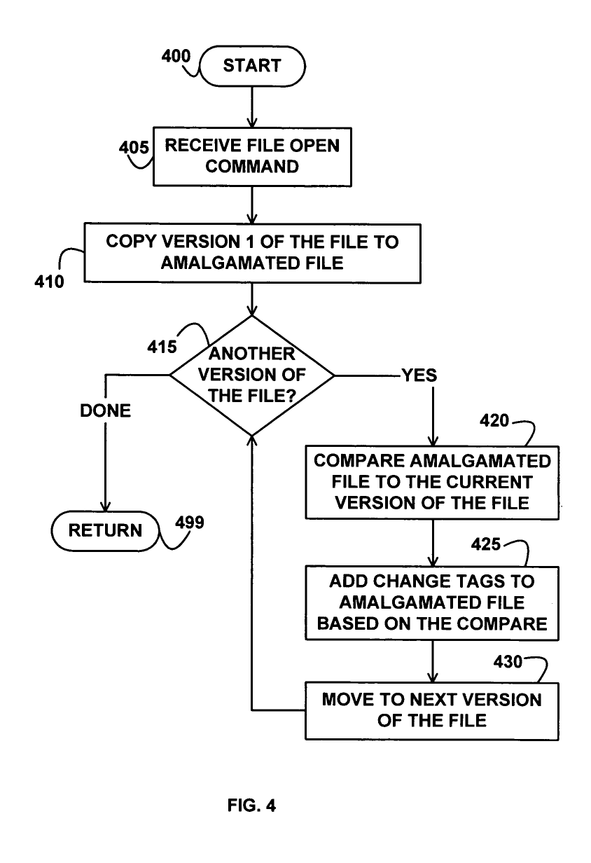

FIG. 4 depicts a flowchart of example processing for a file open command by the editor 150, according to an embodiment of the invention. Control begins at block 400. Control then continues to block 405 where the editor 150 receives a file open command. In an embodiment, the file open command is received from the user interface 200. In another embodiment, the file open command is received programmatically or via any other appropriate means.

Control then continues to block 410 where the editor 150 copies a first version of the file versions 152 to the amalgamated file 154. Control then continues to block 415 where the editor 150 determines whether another version exists in the file versions 152 that is unprocessed by the logic of FIG. 4.

If the determination at block 415 is true, then another unprocessed version (the current version) exists in the file versions 152, so control continues to block 420 where the editor 150 compares the amalgamated file 154 to the current version of the file versions 152. Control then continues to block 425 where the editor 150 adds change tags, e.g., the change tags 305, 310, 315, and 320 (FIG. 3), to the amalgamated file 154 based on the compare previously done at block 420. Control then continues to block 430 where the editor 150 sets the current version to be the next version in the file versions 152. Control then continues to block 415, as previously described above.

If the determination at block 415 is false, then another unprocessed version does not exist in the file versions 152, so control continues to block 499 where the logic of FIG. 4 returns.

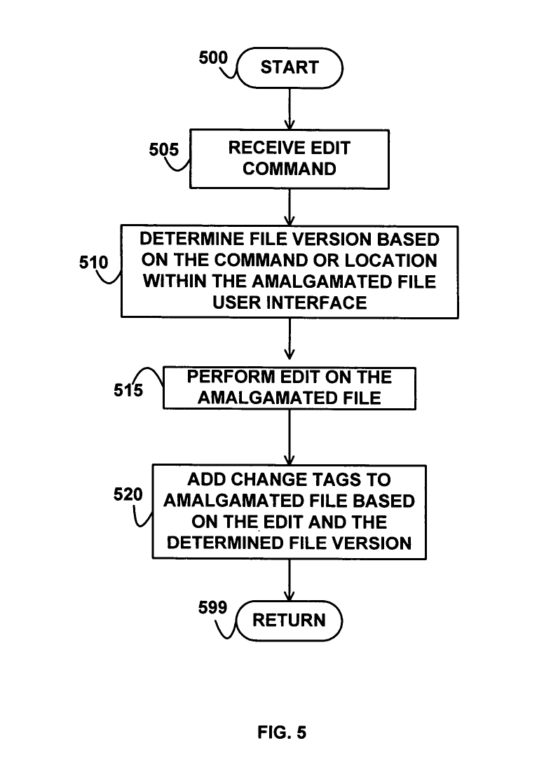

FIG. 5 depicts a flowchart of example processing for an edit command by the editor 150, according to an embodiment of the invention. Control begins at block 500. Control then continues to block 505 where the editor 150 receives an edit command that requests a change to the amalgamated file 154. In various embodiments, the edit command may be a keystroke, a drag and drop operation, a copy and paste operation, a cut and paste operation, a paste operation or any other appropriate command that requests a change to the amalgamated file 154. Any appropriate input device may be used to initiate the command, such as a keyboard, mouse, trackball, pointing device, touchpad, speech-to-text program, or any other appropriate input device. Further, in an embodiment the change need not be immediately implemented in the amalgamated file 154, but may be temporarily stored in a cache, buffer, or other appropriate temporary file.

Control then continues to block 510 where the editor 150 determines the file version based on the command or location with the user interface 200 of the amalgamated file 154 to which the command is directed. For example, if an edit command is directed to data delineated by the change tags 305 and 310 (FIG. 3), then the editor 150 determines that the file version to which the edit command applies is version B since version B is specified in the version field of the change tags 305 and 310. Similarly, if an edit command is directed to data delineated by the change tags 315 and 310 (FIG. 3), then the editor 150 determines that the file version to which the edit command applies is version C since version C is specified in the version field 330 in the change tags 315 and 320. In another embodiment, the processing of block 510 is optional, not used, or unnecessary.

Control then continues to block 515 where the editor 150 changes the amalgamated file 154 or performs the edit based on the command. Control then continues to block 520 where the editor 150 adds change tags to the amalgamated file 154, e.g., the change tags 305, 310, 315, or 320 (FIG. 3).

In another embodiment, the processing of block 520 is optional, not used, or unnecessary. For example, in an embodiment, the editor 150 performs the requested edit at whatever location the user requests without adding change tags to the amalgamated file 154. If the user selects an edit location that is within a pre-existing set of change tags, then the editor 150 saves that edit to the version 330 of the file version 152 that is associated with those pre-existing change tags. In such an embodiment, the change tags are created in FIG. 4, as previously described above, and not in FIG. 5.

Control then continues to block 599 where the logic of FIG. 5 returns.

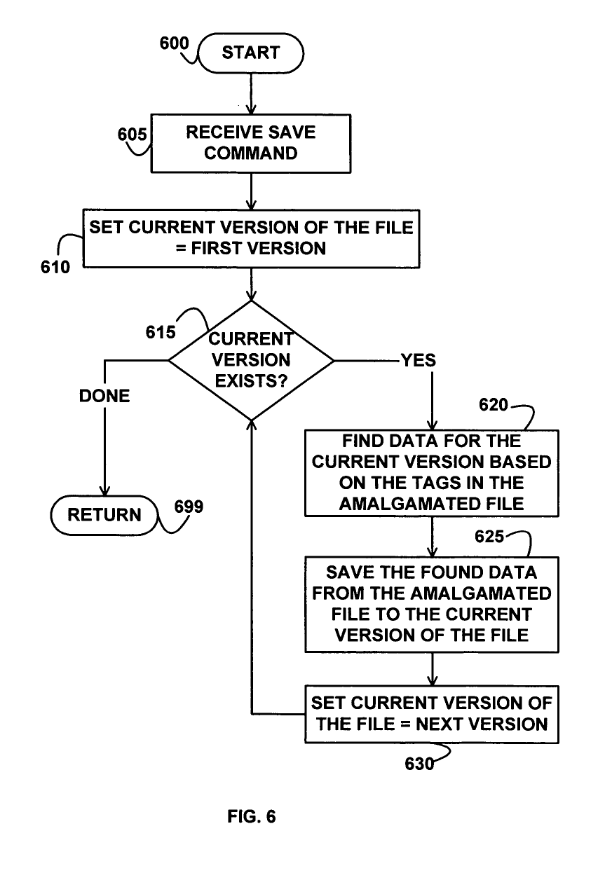

FIG. 6 depicts a flowchart of example processing for a file save command by the editor 150, according to an embodiment of the invention. Control begins at block 600. Control then continues to block 605 where the editor 150 receives a save command via the user interface 200. In other embodiments, the editor 150 may receive the save command programmatically or by any other appropriate means. Control then continues to block 610 where the editor 150 sets the current version to be the first version in the file versions 152. Control then continues to block 615 where the editor 150 determines whether the current version exists.

If the determination at block 615 is true, then the current version in the file versions 152 exists, so control continues to block 620 where the editor 150 finds data for the current version in the amalgamated file 154. The editor 150 finds the data based on the change tags, e.g., the change tags 305, 310, 315, or 320 (FIG. 3) and based on matching the current version to the version field 330 in the change tags.

Control then continues to block 625 where the editor 150 saves the found data from the amalgamated file 154 to the current version of the file versions 152. Control then continues to block 630 where the editor 150 sets the current version to be next version in the file versions 152. Control then returns to block 615, as previously described above.

If the determination at block 615 is false, then all of the file versions 152 have been processed, so control continues to block 699 where the logic of FIG. 6 returns.

FIG. 7 depicts a flowchart of example processing for different views of the amalgamated file 154 by the editor 150, according to an embodiment of the invention. Control begins at block 700. Control then continues to block 705 where the editor 150 receives a view command from the user interface 200, such as commands initiated by the example buttons 205, 210, 215, or 220 or a combination thereof. For example, the command may indicate that the user requests to see only version A (by button 210 from FIG. 2), only version B (by button 215 from FIG. 2), only version C (by button 220 from FIG. 2), all the versions simultaneously (by button 205 from FIG. 2), both version A and version B (by button 210 and button 215 from FIG. 2), both version A and version C (by button 210 and button 220 from FIG. 2), or both version B and version C (by button 215 and button 220 from FIG. 2).

Control then continues to block 710 where the editor 150 determines whether a change tag (e.g., the change tags 305, 310, 315, or 320 in FIG. 3) unprocessed by the logic of FIG. 7 exists in the amalgamated file 154. If the determination at block 710 is true, then a change tag in the amalgamated file 154 exists that is unprocessed by the logic of FIG. 7, so control continues to block 715 where the editor 150 determines whether the version specified by the command is the same as the version specified in edit the tag, e.g., the version 330.

If the determination at block 715 is true, then the version specified by the command is the same as the version specified in the current change tag, so control continues to block 720 where the editor 150 displays data associated with the change tag in the user interface 200. Control then returns to block 710, as previously described above.

If the determination at block 715 is false, then the version specified by the command is not the same as the version specified in the current change tag, so control continues to block 725 where the editor 170 refrains from displaying the data associated with the edit tag or deletes the data associated with the change tag from the display if it is already displayed in the user interface 200. Control then returns to block 710, as previously described above.

If the determination at block 710 is false, then all change tags in the amalgamated file 154 have been processed by the logic of FIG. 7, so control continues to block 799 where the logic of FIG. 7 returns.

The logic of FIG. 7 may be invoked multiple times to cause the editor 150 to switch between views of the amalgamated file 154. For example, the user may view all of the versions individually (buttons 210, 215, and 220 from FIG. 2), then view all versions at the same time (button 205 from FIG. 2), and then view some combination of the versions.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized, and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of the invention. But, the invention may be practiced without these specific details. In other instances, well-known circuits, structures, and techniques have not been shown in detail in order not to obscure the invention.

What is claimed is:

1. A method comprising:
creating an amalgamated file based on differences between a plurality of files;
receiving an edit command directed to the amalgamated file;
determining at least one of the plurality of files to which the edit command applies; and
updating the at least one of the plurality of files.

2. The method of claim 1, wherein the determining further comprises:
determining the at least one of the plurality of files based on a location within the amalgamated file to which the edit command is directed.

3. The method of claim 1, wherein the determining further comprises:
determining the at least one of the plurality of files based on a specification in the edit command.

4. The method of claim 1, further comprising:
adding at least one change tag to the amalgamated file in response to the edit command, wherein the at least one change tag comprises an identification of the at least one of the plurality of files.

5. The method of claim 4, wherein the updating further comprises:
finding the at least one change tag in the amalgamated file; and
saving data identified by the at least one change tag to the at least one of the plurality of files.

6. An apparatus comprising:
means for creating an amalgamated file based on differences between a plurality of files;
means for receiving an edit command directed to the amalgamated file;
means for determining at least one of the plurality of files to which the edit command applies; and
means for adding a change tag to the amalgamated file in response to the edit command, wherein the change tag comprises an identification of the at least one of the plurality of files.

7. The apparatus of claim 6, further comprising:
means for updating the at least one of the plurality of files in response to a save command directed to the amalgamated file.

8. The apparatus of claim 6, wherein the means for determining further comprises:
means for determining the at least one of the plurality of files based on a location within the amalgamated file to which the edit command is directed.

9. The apparatus of claim 6, wherein the means for determining further comprises:
means for determining the at least one of the plurality of files based on a specification in the edit command.

10. The apparatus of claim 6, further comprising:
means for finding the change tag in the amalgamated file; and
means for saving data identified by the change tag to the at least one of the plurality of files.

11. A signal-bearing medium encoded with instructions, wherein the instructions when executed comprise:
creating an amalgamated file based on differences between a plurality of files;
switching between a plurality of views of the amalgamated file, wherein the plurality of views display respective subsets of the differences.

12. The signal-bearing medium of claim 11, wherein one of the plurality of views displays all of the differences between the plurality of files.

13. The signal-bearing medium of claim 11, wherein one of the plurality of views displays the differences for at least two of the plurality of files.

14. The signal-bearing medium of claim 11, further comprising:
receiving an edit command directed to the amalgamated file; and
determining at least one of the plurality of files to which the edit command applies.

15. The signal-bearing medium of claim 14, further comprising:
adding a change tag to the amalgamated file in response to the edit command, wherein the change tag comprises an identification of the at least one of the plurality of files.

16. A computer system comprising:
a processor; and
memory encoded with instructions, wherein the instructions when executed on the processor comprise:
creating an amalgamated file based on differences between a plurality of files,
receiving an edit command directed to the amalgamated file,
determining at least one of the plurality of files to which the edit command applies,
adding a change tag to the amalgamated file in response to the edit command, wherein the change tag comprises an identification of the at least one of the plurality of files,
switching between a plurality of views of the amalgamated file, wherein each of the plurality of views displays a respective subset of the differences, and
updating the at least one of the plurality of files.

17. The computer system of claim 16, wherein the determining further comprises:
determining the at least one of the plurality of files based on a location within the amalgamated file to which the edit command is directed.

18. The computer system of claim 16, wherein the determining further comprises:
determining the at least one of the plurality of files based on a specification in the edit command.

19. The computer system of claim 16, wherein the instructions further comprise:
adding a change tag to the amalgamated file in response to the edit command, wherein the change tag comprises an identification of the at least one of the plurality of files.

20. The computer system of claim 19, wherein the updating further comprises:
finding the change tag in the amalgamated file; and
saving data identified by the change tag to the at least one of the plurality of files.
